(19) United States
(12) Patent Application Publication
(10) Pub. No.: US 2014/0302921 A1
(43) Pub. Date: Oct. 9, 2014

(54) GAMES SYSTEM

(71) Applicant: PlayJam Limited, London (GB)

(72) Inventors: Jasper Smith, London (GB); Anthony Johnson, London (GB)

(21) Appl. No.: 14/147,128

(22) Filed: Jan. 3, 2014

(30) Foreign Application Priority Data
Jan. 15, 2013 (GB) 1300740.6
Jan. 30, 2013 (GB) 1301663.9

(51) Int. Cl. A63F 13/20

(52) U.S. Cl. CPC A63F 13/06
USPC 463/31

(57) ABSTRACT

A games system includes a handheld games controller (12) configured to permit a player to input player commands and output game commands based on the player commands and a games console (14) configured to operate games in response to game commands received from the games controller and output display signals to be received by a display device. The games console (14) is a stick device.

### CROSS REFERENCE TO RELATED APPLICATIONS

This application claims the foreign priority benefit of United Kingdom Patent Application No. 1300740.6 filed 15 Jan. 2013 and United Kingdom Patent Application No. 1301663.9 filed 30 Jan. 2013, both of which are hereby incorporated by reference.

### FIELD OF THE INVENTION

The invention related to games systems.

### BACKGROUND TO THE INVENTION

It is known to provide games systems that comprise a display and audio output device. It is also known to provide games systems that can be connected to a television set to permit the television set to serve as a display and audio output device for the games system. Such games systems may comprise a games console and a player interface (UI) in the form of a handheld game controller. The game controller may include a joystick, switches, buttons and the like to enable the player to input player commands to play a game and is connected to the games console to transmit game commands based on the player commands to the games console. The games console operates a game package in response to the game commands and provides output signals to provide a game display and audio accompaniment that is at least in part instigated by the player commands. These games consoles are typically relatively large devices that are not considered portable and, in particular, are significantly larger than the handheld games controller.

### SUMMARY OF THE INVENTION

The invention provides a games system as specified in claim 1.

The invention also includes a games system as specified in claim 12.

The invention also includes a games system as specified in claim 22.

The invention also includes a games system as specified in claim 25.

The invention also includes a method of operating a games system as specified in claim 29.

The invention also includes a games system as specified in claim 33.

### BRIEF DESCRIPTION OF THE DRAWINGS

In the following disclosure, reference will be made to the drawings, in which:

FIG. 1 is a schematic illustration of a games system and a smart television set;

FIG. 2 is a perspective view of the games system of FIG. 1;

FIG. 3 is a schematic illustration of a games console of the games system of FIG. 1;

FIG. 4 is a flow diagram illustrating a method of using the games system of FIG. 1;

FIG. 5 is a schematic illustration of another games system and a smart television set;

FIG. 6 is a schematic illustration of a docking device of the games system of FIG. 5;

FIG. 7 is a flow diagram illustrating a method of using the games system of FIG. 5;

FIG. 8 is a perspective view of yet another games system;

FIG. 9 is an enlarged cutaway view of a part of a games controller of the games system of FIG. 8; and

FIG. 10 shows a part of an ejection mechanism of the games controller.

### DETAILED DESCRIPTION OF THE ILLUSTRATED EXAMPLES

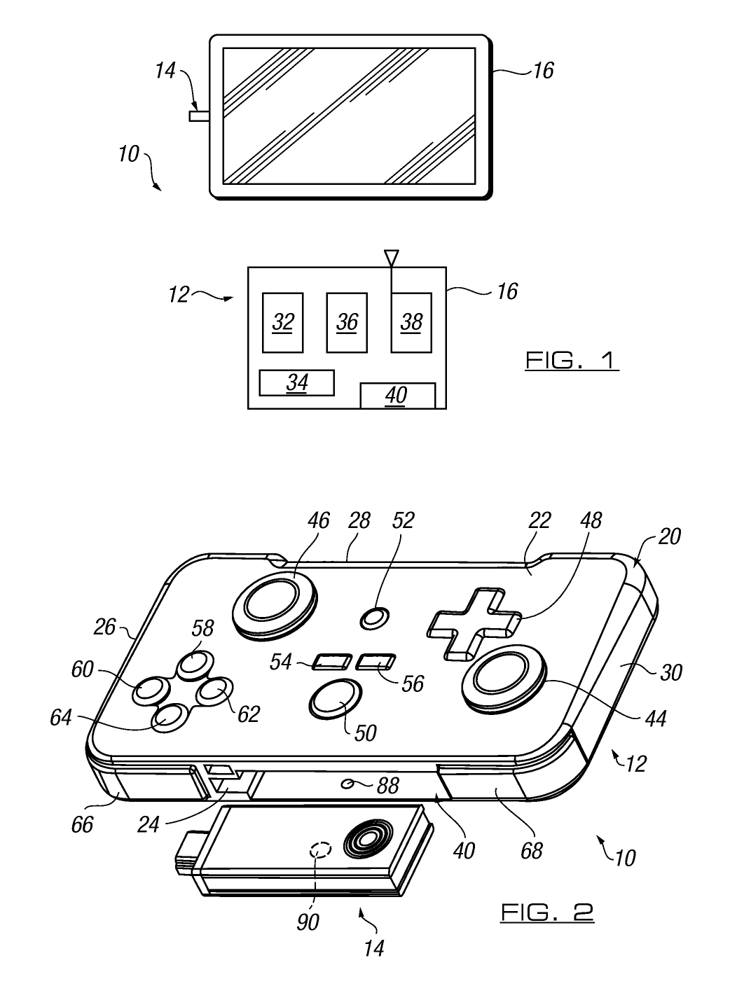

Referring to FIGS. 1 to 3, a games system 10 comprises a handheld games controller 12 and a games console 14. The games console 14 is shown plugged into an audio visual unit in the form of a television set 16 so that the television set can function as a display and audio output device for the games system 10. The television set 16 may be a so-called smart television set.

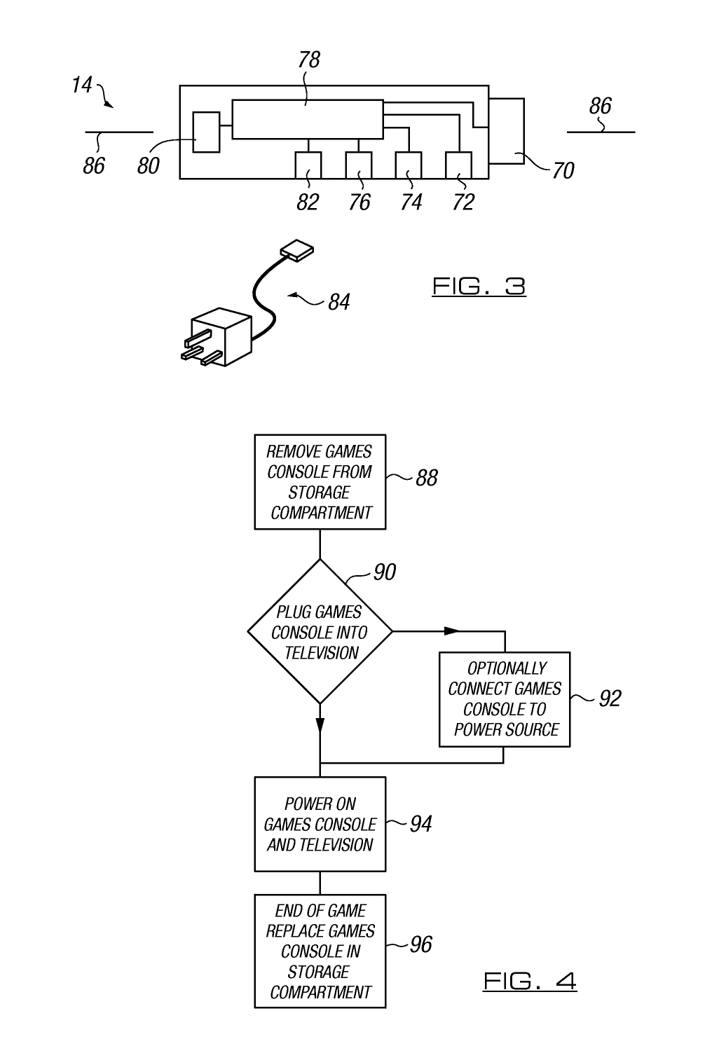

As shown in FIG. 2, the games controller 12 comprises a housing 20. The housing 20 has two major walls 22 (only one of the walls 22 is visible in the drawing) that are disposed in opposed spaced apart relation and side walls 24, 26, 28, 30. The side walls 24, 26, 28, 30 extend around the perimeter of and connect the two major walls 22 to define a generally rectangular enclosure. As shown in FIG. 1, the games controller 12 has a player interface (UI) 32, a power source such as a battery 34, a control system 36, an output device 38 to transmit game commands to the games console 14 and a storage compartment 40 for the games console.

The UI 32 is configured to permit a player to input player commands to play a game. In the example illustrated by FIG. 2, the UI 32 comprises a first (left joystick) 44, a second (right) joystick 46, a D-pad 48, a mode selector 50, a power on/off button 52, a start button 54, a select button 56, button (A) 58, button B (60), button (X) 62, button (Y) 64, left trigger 66 and right trigger 68. In this example, except for the left and right triggers 66, 68, all of the UI interface devices are provided in the upper major wall 22 of the housing 20. The left and right triggers 66, 68 are disposed in openings that are defined in the side wall 24 and extend into the respective side walls 26, 30 that extend from the opposite ends of the side wall 24.

The control system 36 may include a processor running an Android® operating system and support three modes of operation that can be selected using the mode selector 50. The mode selector 50 may include a push button as illustrated in FIG. 2. The three modes of operation are: mouse, keyboard and joystick. The button mapping of mouse, keyboard and joystick is illustrated in the table below.

| Buttons | Keyboard mode | Mouse mode | Joystick mode |
|---|---|---|---|
| Android Version | 2.2+ | 2.2+ | 3.2+ |
| Left trigger 1 | Keycode (5) | Mouse left key | Button (5) |
| Right trigger 1 | Keycode (7) | Mouse right key | Button (6) |
| Dpad left | Keycode (A) | NC | Dpad left |
| Dpad right | Keycode (D) | NC | Dpad right |
| Dpad up | Keycode (W) | NC | Dpad up |
| Dpad down | Keycode (S) | NC | Dpad down |
| Left stick left | Keycode left arrow | NC | X axis |
| Left stick right | Keycode right arrow | NC | X axis |
| Left stick up | Keycode up arrow | NC | Y axis |
| Left stick down | Keycode down arrow | NC | Yaxis |
| Right stick left | Keycode (J) | Mouse Navigation | Z axis |
| Right stick right | Keycode (L) | Mouse Navigation | Z axis |
| Right stick up | Keycode (I) | Mouse Navigation | Z rotor axis |
| Right stick down | Keycode (K) | Mouse Navigation | Z rotor axis |
| A button | Keycode (1) | NC | Button 1 |
| B button | Keycode (2) | NC | Button 2 |
| X button | Keycode (3) | NC | Button 3 |
| Y button | Keycode (4) | NC | Button 4 |
| Select | Keycode (back) | NC | Button 7 |
| Start | Keycode (Enter) | NC | Button 8 |
| Big button | Power On/Off | Power On/Off | Power On/Off |

The output device 38 of the games controller 12 may be a wireless device that uses a Bluetooth protocol to wirelessly transmit game commands to the games console 14. The control system 36 may be configured to receive signals indicative of player commands input via the UI 32 and provide signals indicative of games commands that are based on the player commands. The games commands may be transmitted to the games console 14 by the output device 38.

As best seen in FIG. 3, the games console 14 is a stick device. Although not limited to these dimensions, in one example the stick device is approximately 78 mm long, 27 mm wide and 11 mm deep. The games console 14 may comprises a male high definition multimedia (HDMI) connector 70 to permit it to be connected with a female HDMI connector of the television set 16. In another example the HDMI connector 70 is a female part to connect with a male HDMI connector. The games console 14 additionally comprises a micro USB port 72, a USB 2.0 port 74, a micro SD card slot 76, a controller 78 and a wireless transceiver 80.

The controller 78 may be integrated into a system on chip (SoC), which may be an AML 8726 MX chip. The wireless transceiver 80 in the illustrated example has an internal aerial, or antenna, and operates a Bluetooth protocol.

An example specification for the games console 14 may be as follows:

Hardware

| | |
|---|---|
| CPU | AML 8726 MX Dual Cortex A9 CPU up to 1.5 |
| | Ghz at 7500DMIPS |
| External memory | Up to 32 GB through Micro SD card |
| GPU | DualARMMali400GPU@400 Mhz |
| Internal memory | Nand Flash 8 GB |
| Mobile High-de | To support direct power input to the games |
| Link | console from MHL compatible TVs |
| Ports | 1 × USB 2.0 (or mini USB) Host for external |
| | drive/component |
| | 1 × Micro USB for power |
| | 1 × HDMI1.3 Output - ESD Protection with |
| | RClamps□ |
| Power | 90-230 V, 50/60 Hz input. Max power: 30 W. |
| | Output: 5 V/2 A |
| RAM | DDR3 1 GB |
| Wifi/Bluetooth | WiFi 802.11b/g/n 10/100 Mbps With internal |
| Combo | Antenna |

Software

| | |
|---|---|
| Android | 4.2.0 |
| Browser | Mozilla Version 17+ |
| Gaming | Built-in 3D Accelerator. Support 3D gaming, Open |
| | GL, WebGL |
| Email | Gmail, POP3/SMTP/IMAP4. |

Multimedia

| | |
|---|---|
| Video Decoding | Mpeg1/2/4.H.264, VC1, Divx, Xvid, RM8/9/10, |
| | VP6 |
| Video quality | Full 1080p HD decoding |
| Video Formats | MKV, TS, TP, M2TS, RM/RMVB, BD- |
| | ISO, AVI, MPG, VOB, DAT, ASF, TRP, FLV etc |
| DRM | PlayReady/Widevine |
| Audio | Audio Decoding: DTS, AC3, LPCM, FLAC, |
| | HE-AAC, Dolby |
| | Audio Formats: MP3, OGG, WMA, WMAPRO |
| Picture and ebook | JPEG, PNG, BMP, GIF PDF, TXT etc. |
| support | |

The controller 78 supports HID Bluetooth controllers and PlayJam Ltd's mobile companion application, which allows the control of games using a phone or tablet. The controller 78 supports Bluetooth HID Keyboard/Joystick/Mouse profiles. The controller 78 may use the Bluetooth 3.0 protocol and support Android® games developed for Android® OS 3.2 and up. In one example, the controller 78 may support Android games from Android® OS 4.2 and up. The HID profile may support up to four controllers. The controller 78 may additionally support controllers from Green Throttle Games, such as the Green Throttle Atlas controller.

The games console 14 may be powered directly from the television set 16 and may be configured to work with all MHL compliant television sets to draw power directly from such television sets via the HDMI connector 70. In order to permit use of the games console 14 with older non-MHL compliant television sets, a USB cable may be connected to the micro USB port 72 and used to draw power from the television set. In order to permit the use of the games console 14 with even older television sets that do not support MHL or power through a USB port, the games console 14 may be provided with a power socket 82 to permit connection to a mains electricity supply via a cable and transformer plug 84.

Referring to FIG. 2, the storage compartment 40 in the games controller 12 is configured to receive the games console 14 when not in use and allow the games console to be transported stored within the games controller. The storage compartment 40 extends lengthways parallel and adjacent to the side wall 24 and is accessed via an opening defined in the side wall. The games console 14 is inserted into and removed from the storage compartment 40 by a movement that is at least substantially perpendicular to the longitudinal axis 86 (FIG. 3) of the games console and parallel to plane of the major wall 22. The games console 14 and storage compartment 40 may be provided with means for securing the games console within the storage compartment. For example, the parts may be provided with a cooperating snap-fitting arrangement or mechanism. In one example, one or more spring loaded elements, such as balls 88, may be housed in the storage compartment 40 to engage a corresponding recess(es) 90 provided in the casing of the games console. In other examples, a wall(s) of the storage compartment or games console may be provided with one or more resilient fingers, or members, that are engagabeable in a corresponding recess(es) provided in wall(s) or the casing of the games console. Alternatively, the games controller 12 may be provided with a mechanism for at least partially closing the opening to the storage compartment 40 so as to retain the games console 14 in the storage compartment. For example, a planar element can be pivot mounted on the housing 20 adjacent the opening to the storage compartment 40 so that it may be pivoted between a position in which it is clear of the opening to permit loading/unloading of the games console 14 and a position in which it extends at least partially over the opening, thereby retaining the games console in the storage compartment.

The games console 14 may be powered by PlayJam Limited's backend platform and software development kit. The PlayJam platform provides a convenient route to getting games onto the games console 14. The PlayJam platform permits games developers to develop games using many different development environments that compile to Android®, for example, Unity, Marmalade, Air, Corona, or in C++ or native Java®.

Referring to FIG. 4, in an example of using the games system 10 and starting with the games console 14 stored in the storage compartment 40, as a first step 88 a player wishing to play a game removes the games console from the storage compartment. The next step 90 is to plug the HDMI connector 70 of the games console 14 into a HDMI connector of a television set 16 that is to serve as the display and audio output for the games system. If the television set 16 is not capable of powering the games console via the HDMI connector 70, step 92 is to connect a USB cable to the micro USB port 72 to power the games console from a USB port of the television set or connect the power cable and transformer plug 84 to the power socket 82 and a supply of mains electricity to power the games console from the mains. At step 94 the player powers on the television set 16 and games controller 12 and commences playing a game by inputting player commands via the UI 32. At the end of the game, at step 96, the games console 14 can be disconnected from the television set 16 (and the USB cable or mains electricity supply if it has not been powered via the HDMI connector 70) and stored in the storage compartment 40.

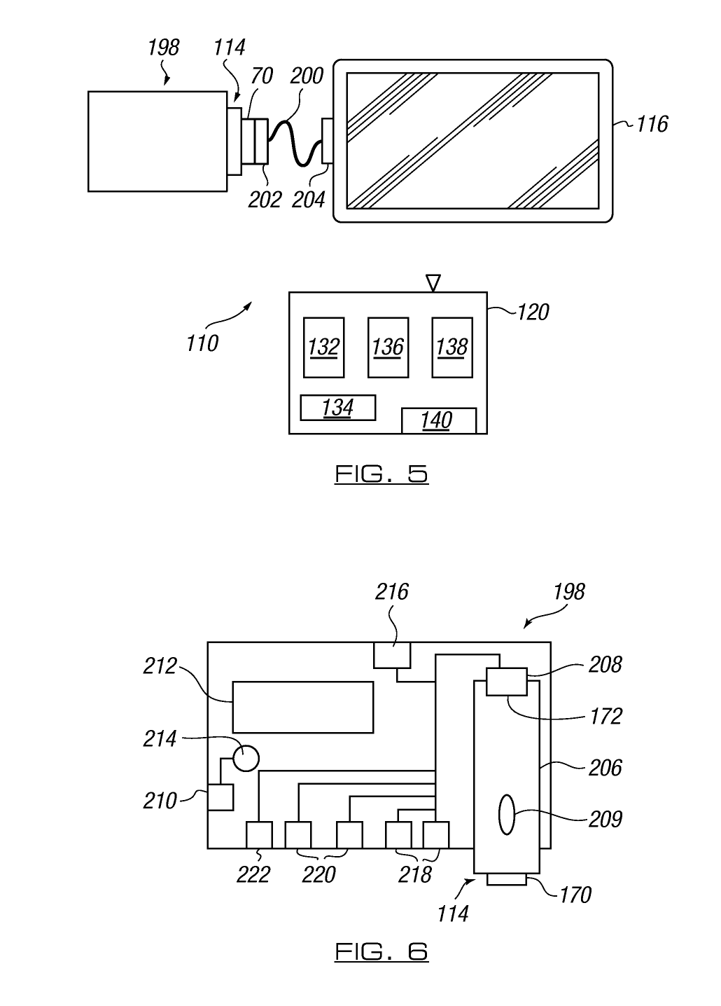

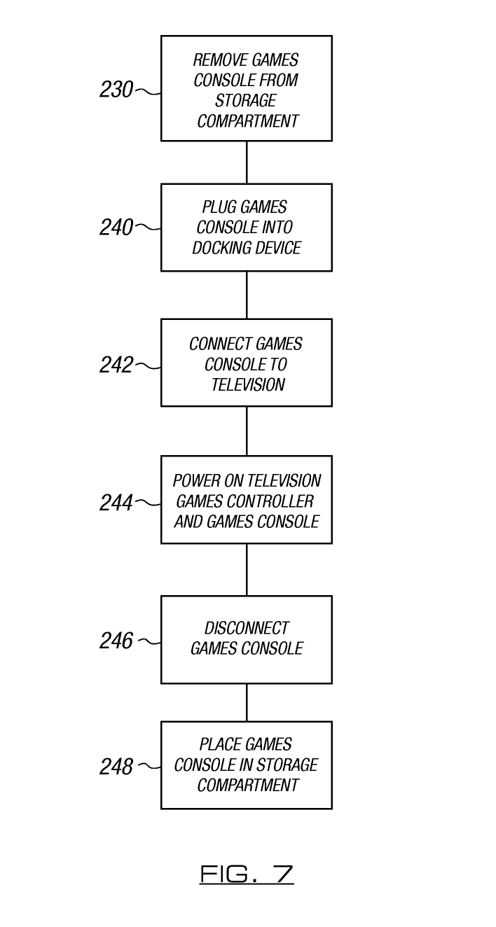

FIGS. 5 and 6 illustrate another example of a games system 110. Parts of the games system 110 that are the same as, or similar to, parts of the games system 10 will be referenced using the same reference numerals incremented by 100 and may not be described in detail again.

The games system 110 comprises a handheld games controller 112, a games console 114 and a docking device, or hub, 198. The games console 114 is shown connected with an audio visual unit in the form of a television set 116 so that the television set can function as a display and audio output device for the games system 110. The television set 116 may be a so-called smart television set. The games console 114 is connected with the television set 116 by a cable 200 that at one end has a female HDMI connector 202 that is connected with the HDMI connector 170 of the games console and at the other end has a male HDMI connector 204 that is plugged into a female HDMI connector (not shown) of the television set.

The principal difference between the games system 10 and the games system 110 is that the latter comprises the docking device or hub 198. Referring particularly to FIG. 6, the docking device 198 comprises a housing that is generally rectangular and may be substantially the same size as the housing 120 of the games controller 112. The docking device 198 comprises a compartment 206 to receive the games console 114. Although not essential, in the illustrated example the compartment 202 extends at least substantially perpendicular to the lengthways direction of the docking device 198. The configuration of the compartment 206 is such that the games console is inserted into and removed from the compartment by a movement that is at least substantially in line with the longitudinal axis 186 of the games console.

At the innermost end of the compartment 206 there is a micro USB plug 208. In this example, the micro USB port 172 of the games console 114 is provided in the end of the games console opposite the end from which the HDMI connector 170 projects so that when the games console is inserted into the compartment 206, the USB port 172 and USB plug 208 can mate to put the games console into communication with the docking device 198.

Optionally, the compartment 206 may be equipped with suitable means to inter-engage the games console 114 to secure it in the compartment. For example, the compartment may be equipped with one or more resilient members (not shown) or one or more spring loaded balls (not shown) that can engage in recess(es) 209 provided in the casing of the games console 114. Thus, the casing of the games console 114 may be provided with features, such as a recess(es) 209 that can be used to secure it in both the storage compartment 140 and the compartment 206. However, in general it is expected that the engagement between the micro USB port 172 and USB plug 208 will be sufficient to ensure the games console 114 is suitably retained in the compartment 206.

The docking device 198 comprises a power socket 210 configured to enable connection to a supply of mains electricity, typically via a cable fitted with a transformer configured to provide the desired wattage to the docking device. The power socket 210 is connected with an internal power supply unit 212 via a power on/off button, or switch, 214. The power supply unit 212 is configured to power the games console 114 wirelessly, for example by means of magnetic resonance or induction charging. This has the advantage that the games console 114 is not dependent on the television set 116 or a direct connection to the mains electricity system for its power supply. As an alternative to a wireless supply, the power supply unit 212 may be connected with a suitable outlet to enable direct connection to a power input device of the games console 114 when the games console is inserted into the compartment 206. For example, the power from the power supply unit may be supplied by a brush-type system engaging a contact provided on the games console.

The docking device 198 additionally comprises an SD card slot 216. The SD card slot allows the insertion of an SD card to provide a memory upgrade for the games console 114. The memory upgrade may be up to 64 GB.

The docking device 198 also comprises various connectors to permit the games console 114 to be put in communication with ancillary, or peripheral, devices. The connectors may comprise two or more female HDMI connectors 218, two or more USB ports 220 and an Ethernet connection 222. The configuration and number of connectors is selected based on the connectivity required and may allow the games console 114 to be put into communication with peripheral devices such as microphones, dance mats, USB controllers, cameras, keyboards or a mouse.

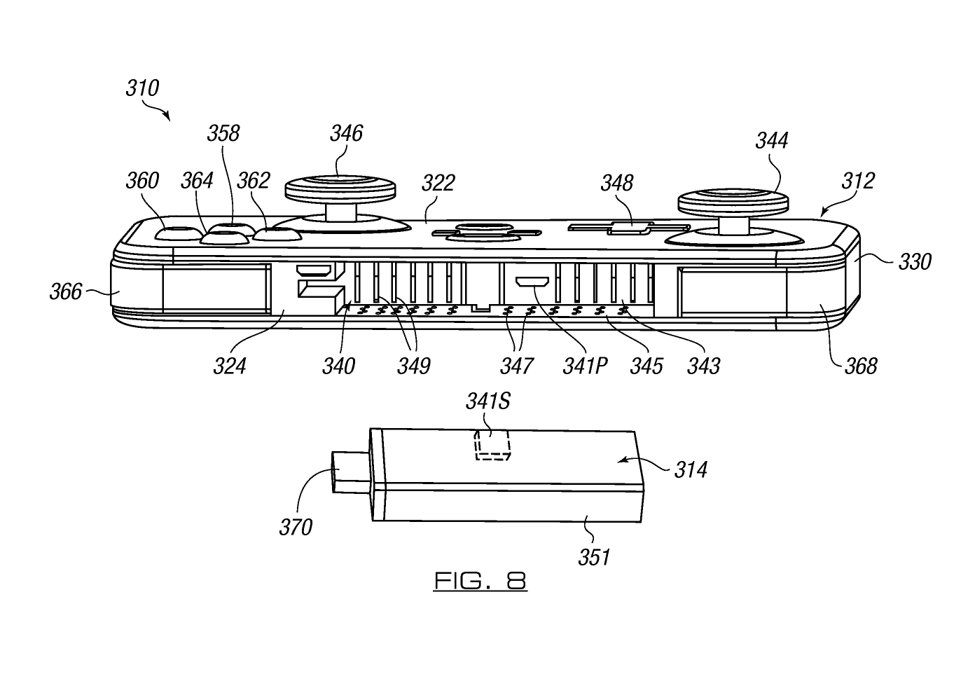

Referring to FIG. 7, in an example of using the games system 110 and starting with the games console 114 stored in the storage compartment 140 of the games controller 112, as a first step 230 a player wishing to play a game removes the games console from the storage compartment. The next step 240 is to plug the games console 114 into the compartment 206 of the docking device 198. The next step 242 is to use the cable 200 to connect the games console 114 with the television set 116 that is to serve as the display and audio output for the games system. At step 244 the player powers on the television set 116, the games controller 112 and the docking device 198 and commences playing a game by inputting player commands via the UI 132. At the end of the game, at step 246, the games console 114 is disconnected from the television set 116 by disconnecting the HMDI connector 202 of the cable 200 from the HDMI connector 170 and from the docking device 198 by pulling it out of the compartment 206. At step 248 the games console 114 is placed in the storage compartment 140 of the games controller 112.

The provision of the docking device 198 allows a player to have a semi-permanent set up that allows the removal of the games controller 112 and games console 114 without disturbing the rest of the set up. Thus, the games console 114 can be readily disconnected from the set up by simply disconnecting the cable 200 from the HDMI connector 170 and removing the games console from the compartment 206. The games console 114 can then be stored in the games controller 112 allowing the player to easily transport the games controller and games console to another location for use with another television set. Reversing the process is as simple as removing the games console from the games controller 112, inserting it in the compartment 206 of the docking device and connecting the cable 200 to the HDMI connector 170. In this way, the player can quickly and easily connect back into a relatively extensive games set up without, for example, having to go behind the television set to establish a connection with the television set.

It is expected that players will typically use the docking device 198 to maintain a semi-permanent set up that can readily be activated by simply connecting the games console 114 to the docking device and cable 200. However, some players may wish to transport the docking device 198 along with the games controller 112 and games console 114. Optionally, the docking device 198 may be made the same size as the games controller and the parts provided with releasable connection means to allow them to be releasably connected for transportation purposes.

Referring to FIGS. 8 to 10, a games system 310 comprises a games controller 312 and a games console 314. Many features of the games controller 312 and games console 314 are the same as, or similar to, features of the games controller 12 and games console 14. Those parts are referenced with the same reference numerals as the parts of the games controller 12 and games console 14 incremented by 300 and may not be described again.

The principal difference between this example and the games system 10 is that the games controller 312 is configured to power the games console 314 and the games console is configured to wirelessly transmit signals to an audio visual unit such as a television set to cause the audio visual unit to function as a display and audio output device for the games system 310 while in situ in the storage compartment 340 of the games controller.

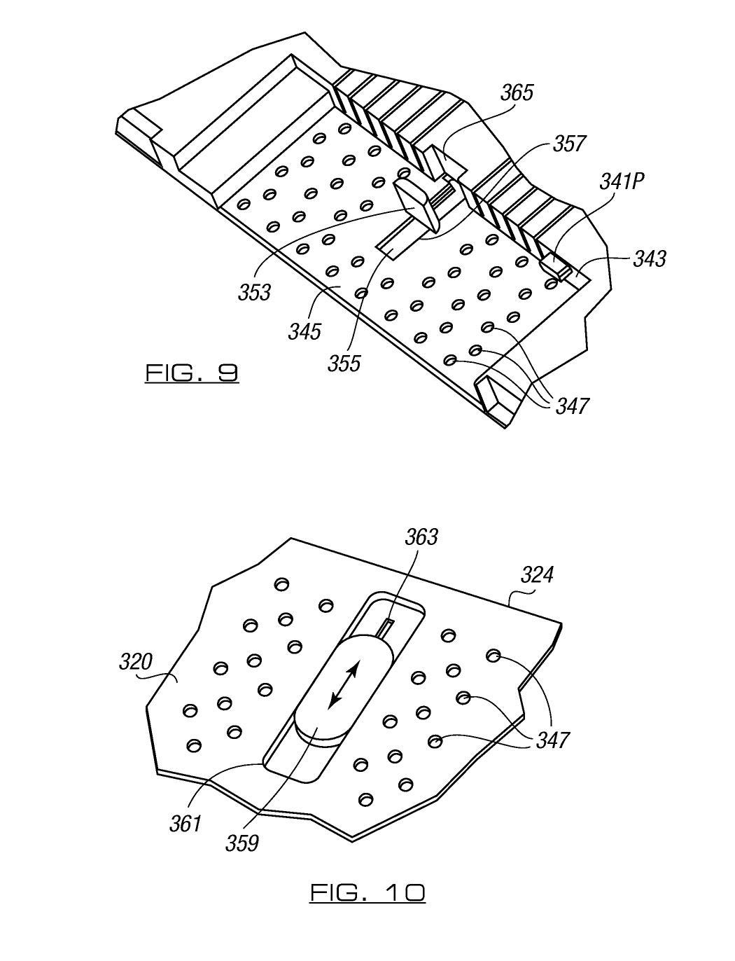

As shown in FIGS. 8 and 9, a micro USB plug 341P is provided in the rear, innermost wall 343 of the storage compartment 340. The USB plug 341P is configured to mate with a micro USB socket 341S in the side of the games console 314 to connect the games console with the games controller's power supply, which may include a suitable battery and power conditioning circuitry to provide a desired power output for the games controller and games console, so that the games console is powered from the games controller.

The base wall 345 of the storage compartment 340 is provided with a plurality of through holes 347 to ventilate the storage compartment and dissipate heat when the games console 314 is being powered by the games controller 312. To assist in providing ventilation in the storage compartment 340, the rear wall 341 is provided with a series of ribs 349 to allow movement of air between the rear wall and the facing side of the games console.

The configuration of the storage compartment 340 is such that when the games console 314 is inserted and the micro USB socket 341S connects with the micro USB plug 341P, the side 351 of the games console is at least substantially flush with the side wall 324 of the games controller 312. This, together with the connection with the USB plug 341P, makes it difficult for a player to remove the games console 314 from the storage compartment 340 by simply gripping the games console and pulling it from the compartment. In order to facilitate removal of the games console 314 from the storage compartment 340, the games controller is provided with an ejection device. As best seen in FIGS. 9 and 10, in the illustrated example the ejection device takes the form of a pusher 353 that projects from a guide member 355. The guide member 355 is located in a guide slot 357 formed in the base wall 345 of the storage compartment 340. The guide slot 357 has a widening at its innermost end that extends beyond the rear wall 343 into the interior of the games controller and which receives a widening at the inner end of the guide member 353. The widening on the inner end of the guide member 355 serves to limit the movement of the pusher 353 away from the rear wall 343. In FIG. 9 the pusher 355 is shown in an extended position at which it would have pushed the games console sufficiently far out of the storage compartment to enable a player to grip the games console and complete the removal process.

Referring to FIG. 10, an actuator button 359 for the pusher 355 is provided in a groove 361 provided in the underside of the games controller housing 320. The button 359 is connected with the guide member 355 via a slot 363 provided in the base of the groove 361. A player can slide the button 359 back and forth in the groove 361 to move the pusher 355 between the extended position shown in FIG. 9 and a position in which it is received in a recess 365 (FIG. 9) provided in the rear wall 343. When the pusher 355 is received in the recess 365, the games console 314 can be fully inserted into the storage compartment to connect the micro USB socket 341S with the micro USB plug 341P.

The games console 314 may be configured to transmit signals to a television set using the Miracast® display standard. The Android® 4.2 will support Miracast®. The Miracast® display standard is able to copy signals from one device to another using the H.264 codec and its own digital rights management (DRM) layer emulating the HDMI system and so the games console may be able to provide all of the functionality of the games console 14 with its HDMI plug and socket connection to television set.

The games system 310 is configured to allow a games console 314 to be incorporated into a handheld games controller 312. The games console 314 is powered from the games controller 312 and can communicate with a television set while housed in the storage compartment 340 in the games controller so that it can operate in situ in the compartment. In effect the only hardware a player needs is the games controller and a games console that can be used in a mode in which it is effectively an integral part of the games controller. The games system 310 is truly portable and all the player has to do in order to play a game is connect wirelessly to a suitable television set. The set up is so straightforward, all the player needs to do is power up the television set and the games controller and the games system is ready for use.

In the illustrated example, the games console 314 has a HDMI plug 370 so that it can be connected with a television set in the same way as the games console 14. Although in some examples, the HDMI plug 370 may be omitted, it may be desirable to have a plug so that the games system 310 can be used with television sets that do not support a suitable wireless connection system. Also, it is not essential that the connection between the games controller 12 and games console 314 is via a micro USB plug and socket as any other suitable connection may be used.

In the illustrated examples, the compartments for the games consoled provided in the games controller and docking device are substantially closed enclosures having an opening on one side to permit loading/unloading of the games console. In other examples, the compartments may be open on more than one side and may comprise an open recess provided in the upper major wall of the games controller or docking device.

The games systems provide a high specification games playing experience with apparatus having a small form factor that includes a games console that can be stored within a handheld games controller. Typically, the games controller is pocket sized and since the games systems can utilise a television as a display and audio output device, the games systems are highly portable.

By providing storage for the games console within the games controller, the likelihood of the games console being lost may be reduced.

The description above refers to use of the example games systems with an audio visual unit in the form of a television set that may provide audio and visual output. It is to be understood that games systems in accordance with the invention are not limited to use with television sets. The games system may be used with any suitable display device that can provide a visual display based on output display signals received from the games system. The games systems may be used with any suitably configured display device that can display a video output, for example, an LCD or LED computer monitor, which may optionally include speakers to provide an audio output. The display device may optionally include an audio output capability. In other examples, the games system may communicate with separate display and audio output devices. The games console may connect with the display device via an HDMI connector or wirelessly.

The provision of the games console as a stick device allows the games system to be readily upgraded by simply replacing the stick device if a higher performance model becomes available, for example, if a stick device with a quad core rather than a dual core processor becomes available the games system can be upgraded by simply acquiring a new stick device. The same games controller and, if provided, docking unit can continue to be used.

1. A games system comprising:
a handheld games controller configured to permit a player to input player commands and to output game commands based on said player commands; and
a games console configured to operate games in response to game commands received from said games controller and output display signals to be received by a display device, wherein said games console comprises a stick device.

2. A games system as claimed in claim 1, wherein said games controller comprises a compartment to house said games console.

3. A games system as claimed in claim 2, wherein said games controller comprises a housing having opposed major walls and side walls connecting said opposed major walls to define an enclosure and one said side wall is provided with an elongate opening to permit insertion of said games console into said compartment.

4. A games system as claimed in claim 1, wherein said games console has a longitudinal axis and said storage compartment is configured such that said games console is loaded into said storage compartment by a movement at least substantially perpendicular to said longitudinal axis.

5. A games system as claimed in claim 1, wherein said compartment is provided with a retaining mechanism configured to retain said games console in said compartment.

6. A games system as claimed in claim 5, wherein said retaining mechanism comprises at least one member that is interengagable with a formation provided on an exterior surface of said games console.

7. A games system as claimed in claim 1, wherein said games console comprises a high definition multimedia (HDMI) connector to permit connection with a high definition multimedia (HDMI) connector of said display device.

8. A games system as claimed in claim 7, wherein said games console comprises an MHL link to permit powering of said console from said display device via said HDMI connector.

9. A games system as claimed in claim 1, wherein said games console comprises at least one of:
i) a USB port to permit powering of said games console from said display device via a USB cable; and
ii) a power socket to permit powering of said games console from a mains electricity supply via a power cable and a transformer unit.

10. A games system as claimed in claim 1, wherein said games console is configured to output audio signals to be received by said display device.

11. A games system as claimed in claim 1, wherein said games console comprises a system on chip (SoC).

12. A games system comprising:
a handheld games controller configured to permit a player to input player commands and to output game commands based on said player commands; and
a games console configured to operate a game in response to game command signals from said games controller and output display signals to be received by a display device,
wherein said games controller comprises a storage space configured for storing said games console when said games console is not in use.

13. A games system as claimed in claim 12, wherein said games controller comprises a housing having opposed major walls and side walls connecting said opposed major walls to define an enclosure and at least one of said sidewalls is configured to define an elongate opening to permit insertion of said games console into said storage space.

14. A games system as claimed in claim 12, wherein said games console has a longitudinal axis and said storage compartment is configured such that said games console is loaded into said storage space by a movement at least substantially perpendicular to said longitudinal axis.

15. A games system as claimed in claim 12, wherein said storage space is provided with a retaining mechanism configured to retain said games console in said storage space.

16. A games system as claimed in claim 15, wherein said retaining mechanism comprises at least one member that is interengagable with a formation provided on an exterior surface of said games console.

17. A games system as claimed in claim 12, wherein said games console comprises a high definition multimedia (HDMI) connector to permit connection with a high definition multimedia (HDMI) connector of said display device.

18. A games system as claimed in claim 17, wherein said games console comprises an MHL link to permit powering of said console from said display device via said HDMI connector.

19. A games system as claimed in claim 12, wherein said games console comprises at least one of:
i) a USB port to permit powering of said games console from a said display device via a USB cable; and
ii) a power socket to permit powering of said games console from a mains electricity supply via a power cable and a transformer unit.

20. A games system as claimed in claim 12, wherein said games console is configured to output audio signals to be received by said display device.

21. A games system as claimed in claim 12, wherein said games console comprises a system on chip (SoC).

22. A games system comprising:
a games console comprising a stick device configured to operate games in response to game commands received from a games controller and output display signals to be received by a display device; and
a docking device for said games console, said docking device comprising at least one first connector configured to permit connection of said docking device with a peripheral device and a second connector connectable with a connector of said games console to permit communication of signals from a said peripheral device connected with said at least one first connector to said games console via the docking device.

23. A games system as claimed in claim 22, wherein said docking device comprises a compartment configured to at least partially receive said games console.

24. A games system as claimed in claim 23, wherein said docking device comprises a third connector configured to connect with an external electrical power supply and a power supply unit connected with said third connector and configured to wirelessly transmit electrical power to said games console when said games console is received in said compartment.

25. A games system comprising:
a games console configured to operate games in response to game commands received from a games controller and output display signals to be received by a display device, said games console being a stick device; and
a docking device for said games console, said docking device comprising a first connector for connecting with an external electrical power supply, a compartment for at least partially receiving said games console and a power supply unit connected with said first connector and configured to wirelessly transmit electrical power to said games console when docked in said compartment.

26. A games system as claimed in claim 25, wherein said games console comprises a connector and said docking device comprises a second connector arranged to engage said connector of said games console when said games console is docked in said compartment.

27. A games system as claimed in claim 26, wherein said docking device comprises at least one third connector configured to permit connection of said docking device with a peripheral device, said at least one third connector being connected with said second connector to permit transmission of signals between said peripheral device and said games console via said docking device.

28. A games system as claimed in claim 23, wherein said games console has a longitudinal axis and said compartment is configured such that said games console is loaded into said compartment by a movement at least substantially in line with said longitudinal axis.

29. A method of operating a games system, said method comprising:
removing a games console from a storage space in a handheld games controller;
connecting said games console with a display device that is to serve as a display for said games system;
inputting player commands to said handheld games controller;
outputting game commands based on said player commands from said games controller;
receiving said game commands at said games console;
processing said game commands in said game console to play a game stored in said games console; and
outputting display signals to said display device to provide a game display.

30. A method as claimed in claim 29, further comprising connecting said games console with said display device by docking said games console in a docking device that is connected with said display device.

31. A method as claimed in claim 30, further comprising connecting said games console with at least one peripheral device via said docking device.

32. A method as claimed in claim 30, further comprising wirelessly transmitting electrical power from said docking device to said games console to power said games console.

33. A games system comprising:
a handheld games controller configured to permit a player to input player commands and to output game command signals based on said player commands; and
a games console configured to operate a game in response to game command signals received from said games controller and output display signals to be received by a display device,
wherein said games controller comprises a compartment configured to house said games console and said games console is configured to operate when housed in said compartment.

34. A games system as claimed in claim 33, wherein said games console is configured to output audio signals to be received by said display device.

35. A games system as claimed in claim 33, wherein said games controller comprises a housing having opposed major walls and side walls connecting said opposed major walls to define an enclosure and at least one said sidewall is configured to define an elongate opening to permit insertion of said games console into said compartment.

36. A games system as claimed in claim 33, wherein said games console has a longitudinal axis and said storage compartment is configured such that said games console is loaded into said storage compartment by a movement at least substantially perpendicular to said longitudinal axis.

37. A games system as claimed in claim 33, wherein said compartment is provided with an ejection mechanism operable to at least partly eject said games console from said compartment.

38. A games system as claimed in claim 37, wherein said ejection mechanism comprises a pusher provided in said compartment and slideable between a retracted position and an extended position to push the games console outwardly of the compartment.

39. A games system as claimed in claim 33, wherein said games console comprises a high definition multimedia (HDMI) connector to permit connection with a high definition multimedia (HDMI) connector of said display device.

40. A games system as claimed in claim 39, wherein said games console comprises an MHL link to permit powering of said console from said display device via said HDMI connector.

41. A games system as claimed in claim 33, wherein said games console comprises at least one of:
i) a USB port to permit powering of said games console from a said display device via a USB cable; and
ii) a power socket to permit powering of said games console from a mains electricity supply via a power cable and a transformer unit.

42. A games system as claimed in claim 33, wherein said games console is configured to transmit said signals to said display device wirelessly.

43. A games system as claimed in claim 33, wherein said games console comprises a system on chip (SoC).

44. A games system as claimed in claim 33, wherein said games controller is configured to power said games console when said games console is housed in said compartment.

45. A games system as claimed in claim 44, wherein said games controller and games console are provided with a plug and socket system configured such that the plug and socket connect to couple said games console with a power supply system of said games console when said games console is inserted into said compartment.

46. A games console as claimed in claim 44, wherein said compartment is provided with a ventilation system.
